(19) United States
(12) Patent Application Publication
(10) Pub. No.: US 2014/0118367 A1
(43) Pub. Date: May 1, 2014

(54) ELECTRONIC DEVICE AND POWER CONTROL METHOD THEREOF

(71) Applicants: INVENTEC (PUDONG) TECHNOLOGY CORPORATION, Shanghai (CN); INVENTEC CORPORATION, Taipei (TW)

(72) Inventors: Shih-Jie Chen, Taipei (TW); Sean-Hau Chang, Taipei (TW)

(73) Assignees: INVENTEC CORPORATION, Taipei (TW); INVENTEC (PUDONG) TECHNOLOGY CORPORATION, Shanghai (CN)

(21) Appl. No.: 13/777,906

(22) Filed: Feb. 26, 2013

(30) Foreign Application Priority Data
Oct. 29, 2012 (CN) 201210421965.9

(51) Int. Cl. G06F 1/32

(52) U.S. Cl. CPC G06F 1/3287
USPC 345/520

(57) ABSTRACT

The electronic device includes a central processing unit and a graphics processing unit. The graphics processing unit is coupled to the central processing unit. The graphics processing unit includes multiple output interfaces. A power is supplied to the graphics processing unit and the output interfaces through the coupling between the output interfaces and an expanded device. Under the condition that the output interfaces are not coupled to the expanded device, the power is stopped supplying to the graphics processing unit and the output interfaces when the electronic device is under a first power supply mode. Moreover, under the condition that the output interfaces are not coupled to the expanded device, the power is supplied to the graphics processing unit and is stopped supplying to the output interfaces when the electronic device is under a second power supply mode.

### CROSS-REFERENCE TO RELATED APPLICATIONS

This non-provisional application claims priority under 35 U.S.C. §119(a) on Patent Application No(s). 201210421965.9 filed in China, P.R.C. on 29 Oct. 2012, the entire contents of which are hereby incorporated by reference.

### BACKGROUND OF THE INVENTION

1. Technical Field of the Invention

The disclosure relates to a power control method, and more particularly to an electronic device with a graphics processing unit and a power control method thereof.

2. Description of the Related Art

Central processing unit (CPU) is a major tool of an electronic device with computer system configured for performing and computing algorithm. In order to meet the ever-growing video processing requirements, in addition to the central processing unit, most display cards disposed on the motherboard is also equipped with an independent graphics processing unit (GPU) and display memory. Thereby, video data processing speed is enhanced.

The structure of graphics processing unit is commonly divided into two types, namely discrete GPU and unified memory architecture (UMA) GPU. For discrete GPU, the video data output interface such as display port (DP), video graphics array (VGA) interface, and low-voltage differential signaling (LVDS) interface, high definition multimedia interface (HDMI) or digital visual interface (DVI) is disposed on a same chip together with the graphics processing unit.

However, as the graphical function of graphics processing unit enhances, the amount of electricity required by the operations of graphics processing unit and the above-mentioned output interfaces also increases substantially. Furthermore, a quantity of connectors of some high-end graphics processing units connected to the power has to increase, so as to obtain a larger amount of electricity for operation. Therefore, conventional graphics processing unit is usually uneconomic in terms of power consumption. Furthermore, since the quantity of graphics processing unit connectors is increased, the cost for manufacturing the graphics processing unit by manufacturers rises accordingly.

### SUMMARY OF THE INVENTION

The disclosure provides an electronic device comprising a central processing unit and a graphics processing unit. The graphics processing unit is coupled to the central processing unit. The graphics processing unit comprising a plurality of output interfaces. A power is supplied to the graphics processing unit and the output interfaces through the coupling between the output interfaces and an expanded device. Under the condition that the output interfaces are not coupled to the expanded device, the power is stopped supplying to the graphics processing unit and the output interfaces when the electronic device is under a first power supply mode. The power is supplied to the graphics processing unit and is stopped supplying to the output interfaces when the electronic device is under a second power supply mode, under the condition that the output interfaces are not coupled to the expanded device.

Moreover, a power control method configured for an electronic device is provided. The electronic device comprises a central processing unit and a graphics processing unit. In the power control method, a power is supplied to the graphics processing unit and the output interfaces respectively, under the condition that the output interfaces of the graphics processing unit are coupled to an expanded device. The power is stopped supplying to the graphics processing unit and the output interfaces respectively when the electronic device is under a first power supply mode, under the condition that the output interfaces are not coupled to the expanded device. The power is supplied to the graphics processing unit and stopping supplying the power to the output interfaces when the electronic device is under a second power supply mode, under the condition that the output interfaces are not coupled to the expanded device.

### BRIEF DESCRIPTION OF THE DRAWINGS

The disclosure will become more fully understood from the detailed description given herein below for illustration only, and thus does not limit the disclosure, wherein:

FIG. 1 is a block diagram of an electronic device according to a first embodiment of the disclosure;

FIG. 2 is a flow chart of a power control method according to the first embodiment of the disclosure;

FIG. 3 is a block diagram of the electronic device according to a second embodiment of the disclosure; and

FIG. 4 is a flow chart of the power control method according to the second embodiment of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### A First Embodiment

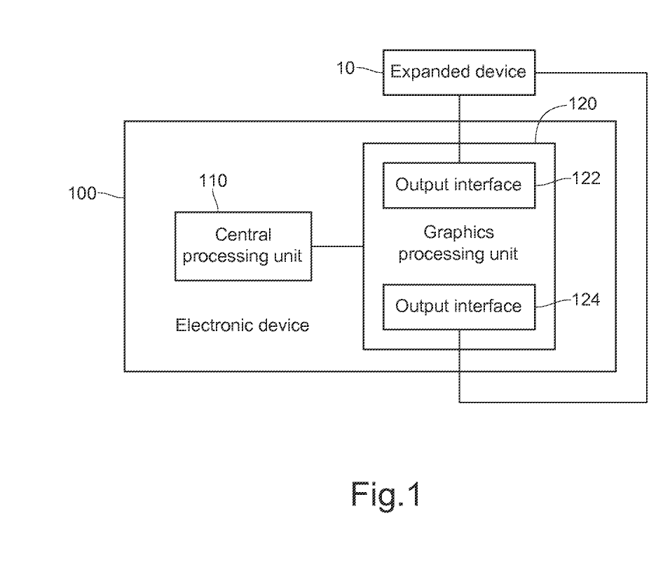

Please refer to FIG. 1. FIG. 1 is a block diagram of an electronic device 100 according to a first embodiment of the disclosure. In this and some other embodiments, the electronic device 100 is a laptop, a tablet computer, a personal digital assistant (PDA), a mobile phone, a digital camera, an electronic book or a game console.

However, the type of the electronic device 100 should not be construed as a limitation to the disclosure. The electronic device 100 comprises a central processing unit (CPU) 110 and a graphics processing unit (GPU) 120. Functions of the above mentioned elements are described hereinafter.

The central processing unit 110 is configured for controlling the overall operations of the electronic device 100. In this and some other embodiments, the central processing unit 110 is able to process video data computing tasks. For example, when a user does not need the electronic device 100 to perform high performance video data processing, the electronic device 100 may process the video data through the central processing unit 110.

The graphics processing unit 120 is coupled to the central processing unit 110. For example, the graphics processing unit 120 is coupled to the central processing unit 110 through a PEG (namely peripheral component interconnect express graphic or PCI-E graphic) bus. The graphics processing unit 120 is a microprocessor specialized for processing video data computing. For example, when the user needs the electronic device 100 to perform high performance video data processing, the electronic device 100 may process the video data through the graphics processing unit 120. Furthermore, the graphics processing unit 120 may be disposed on a motherboard of the electronic device 100 together with the central processing unit 110, or may be disposed on an independent processing card, such as a graphic card, electrically coupled to the central processing unit 110.

Specifically, the graphics processing unit 120 in this and some other embodiments has a plurality of output interfaces. Output interfaces 122 and 124 are used herein for examples. Nonetheless, a quantity of the output interfaces should not be construed a limitation to the disclosure. In this and some other embodiments, the output interfaces 122 and 124 are video transmission interfaces. In this and some other embodiments, video transmission interfaces is display port (DP), video graphics array (VGA) interface, low-voltage differential signaling (LVDS) interface, high definition multimedia interface (HDMI) or digital visual interface (DVI). The graphics processing unit 120 is coupled to an external device through the output interfaces 122 and 124. Thereby, processed video data, such as video streaming, is outputted to the external device. The external device is, for example, an expanded device 10 or other electronic devices with the above mentioned output interfaces.

In this and some other embodiments, the output interface 122 has two display ports, and the output interface 124 has one VGA interface. The graphics processing unit 120 is coupled to the expanded device 10 through the output interfaces 122 and 124. The expanded device 10 is, for example, a docking station. In this and some other embodiments, the output interfaces 122 and 124 are configured for being disposed on a same cable. The cable is configured for being selectively coupled to the expanded device 10. In other words, the output interfaces 122 and 124 are simultaneously coupled or not coupled to the expanded device 10. In this and some other embodiments, since the expanded device 10 is configured for being supplied with power through an external power source (e.g. an alternating current power source or a direct current power source), when the graphics processing unit 120 is coupled to the expanded device 10 through the output interfaces 122 and 124, the power source of the expanded device 10 is supplied to the graphics processing unit 120 through the output interfaces 122 and 124. Thereby, the electronic device 100 is configured for being supplied with power by the external power source through the expanded device 10. As a result, an amount of power consumption of a battery of the electronic device 100 may be reduced.

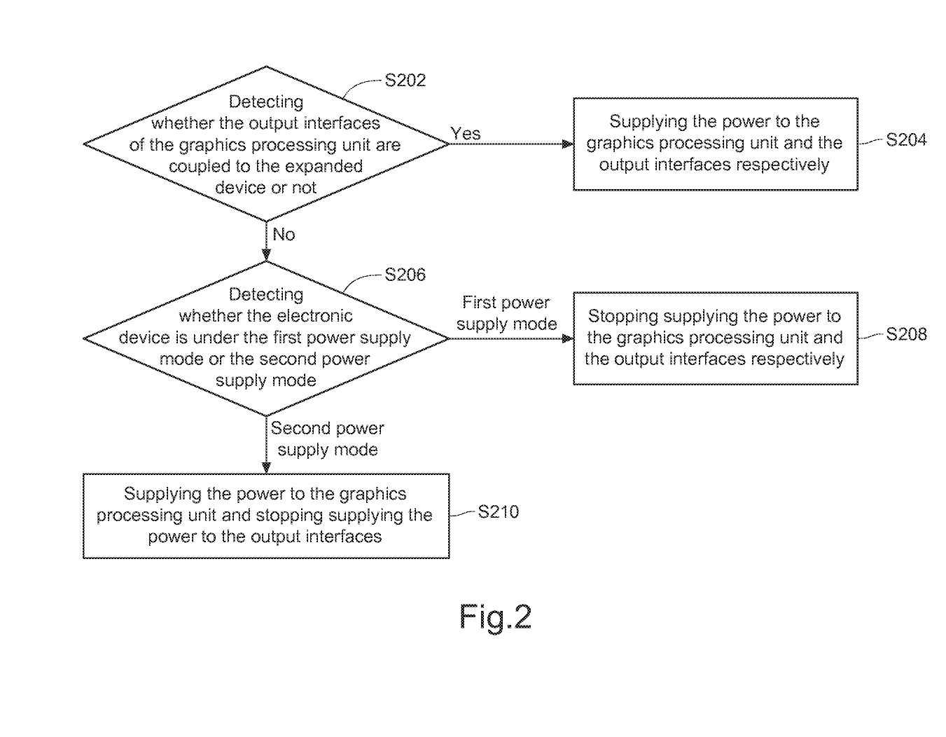

Steps of the power control method of this embodiment used with the electronic device 100 are described hereinafter. FIG. 2 is a flow chart of the power control method according to the first embodiment of the disclosure. Please refer to FIGS. 1 and 2 at the same time. In step S202, the electronic device 100 detects whether the output interfaces 122 and 124 of the graphics processing unit 120 are coupled to the expanded device 10 or not.

Under the condition that the output interfaces 122 and 124 of the graphics processing unit 120 are coupled to the expanded device 10 (as shown in step S204), the graphics processing unit 120 as well as the output interfaces 122 and 124 are respectively supplied with the power through the electronic device 100. In other words, at this point, the expanded device 10 is configured for supplying the power to the electronic device 100. Therefore, when the electronic device 100 is coupled to the expanded device 10, the graphics processing unit 120, the output interface 122 and the output interface 124 are directly supplied with the power. Thereby, the graphics processing unit 120 is configured for processing video data, and the processed video data is outputted to the expanded device 10 through the output interface 122 or the output interface 124.

On the other hand, under the condition that the output interfaces 122 and 124 of the graphics processing unit 120 are not coupled to the expanded device 10, as shown in step S206, the electronic device 100 further detects if the current power supply mode is under a first power supply mode or a second power supply mode. The first power supply mode, for example, the power is stopped supplying to the graphics processing unit 120 and the output interfaces 122 and 124. The second power supply mode, for example, the power is only stopped supplying to the output interfaces 122 and 124 of the graphics processing unit 120, but is still supplied to the graphics processing unit 120 continuously. In this and some other embodiments, the first power supply mode is a unified memory architecture (UMA) mode, and the second power supply mode is a discrete mode.

For example, a flag may be set in a firmware or other storage and recording media, and a setting interface or a hotkey is provided for the user to set a power supply mode under the condition that the output interfaces 122 and 124 of the graphics processing unit 120 are not coupled to the expanded device 10. For example, the flag value is set as 1 when the first power supply mode is set as the power supply mode; and the flag value is set as 0 when the second power supply mode is set as the power supply mode. Thereby, the electronic device 100 is configured for detecting whether it is under the first power supply mode or the second power supply mode by reading the flag. However, the above description is merely used as an example which should not be construed as a limitation to the disclosure.

In this and some other embodiments, when the output interfaces 122 and 124 of the graphics processing unit 120 are not coupled to the expanded device 10, the expanded device 10 does not supply the power to the electronic device 100. At this point, the power required for the operations of elements in the electronic device 100 is supplied by a power supply (e.g. a battery) in the electronic device 100. For example, the power supply supplies the power based on the first power supply mode and the second power supply mode.

In step S208, when the electronic device 100 is under the first power supply mode, the electronic device 100 stops supplying the power to the graphics processing unit 120 as well as the output interfaces 122 and 124. That is, the graphics processing unit 120 as well as the output interfaces 122 and 124 will not be supplied with the power, and therefore the graphics processing unit 120 will not process the video data and the video data is unable to be outputted through the output interfaces 122 and 124. In other words, when the electronic device 100 is under the first power supply mode, the electronic device 100 processes the video data through the central processing unit 110.

On the other hand, when the electronic device 100 is under the second power supply mode as shown in step 5210, the electronic device 100 supplies the power to the graphics processing unit 120 and stops supplying the power to the output interfaces 122 and 124. That is, the graphics processing unit 120 is still supplied with the power for processing the video data. However, the output interfaces 122 and 124 are not supplied with the power. Therefore, the graphics processing unit 120 is unable to output the video data through the output interfaces 122 and 124. In other words, when the electronic device 100 is under the second power supply mode, the video data is processed by the graphics processing unit 120. Nevertheless, the video data processed by the graphics processing unit 120 will not be outputted through the output interfaces 122 and 124. Instead, the processed video data is transmitted via a port interface of the central processing unit 110 to the video transmission interface (e.g. display port, VGA interface, HDMI or DVI) on the motherboard, and then outputted by the video transmission interface.

Thereby, the electronic device 100 is configured for controlling the power supply of the graphics processing unit 120 and the power supply of the output interfaces 122 and 124 based on whether the graphics processing unit 120 is coupled to the expanded device 10 or not, and the power supply mode (e.g. the first power supply mode or the second power supply mode) the electronic device 100 is under. In other words, when the electronic device 100 is coupled to the expanded device 10, the electronic device 100 is, for example, under an alternating current (AC) power mode. When the electronic device 100 is not coupled to the expanded device 10, the electronic device 100 is, for example, under a battery power mode. Thereby, when the electronic device 100 is coupled to the expanded device 10, the power of the battery is not consumed. At this point, the power for the graphics processing unit 120 and its output interfaces 122 and 124 is turned on. When the electronic device 100 is under the battery power mode, the power is stopped supplying to the output interfaces 122 and 124 regardless of the power supply mode the electronic device 100 is under, and whether the graphics processing unit 120 is supplied with the power is based on the power supply mode.

In order to describe the power control method in detail, another embodiment is provided hereinafter.

### A Second Embodiment

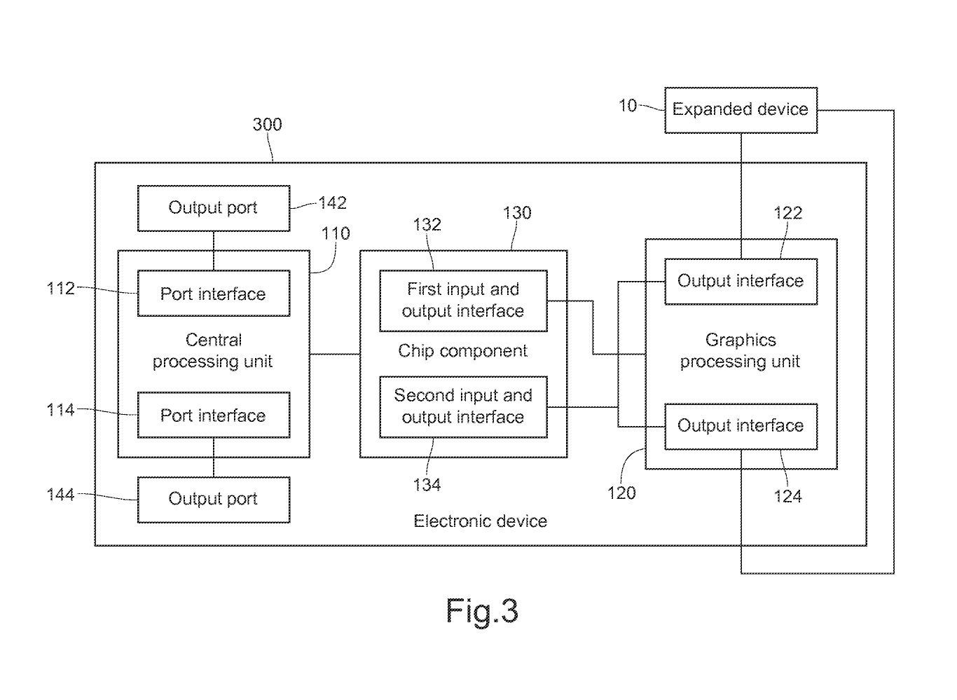

FIG. 3 is a block diagram of an electronic device 300 according to a second embodiment of the disclosure. Please refer to FIG. 1 and FIG. 3 at the same time. The electronic device 300 in FIG. 3 is similar to the electronic device 100 in FIG. 1. The differences between the electronic device 300 and the electronic device 100 lie in that the electronic device 300 in FIG. 3 further comprises a chip component 130 and output ports 142 and 144. The differences between the electronic device 300 and the electronic device 100 further includes that the central processing unit 110 comprises port interfaces 112 and 114. Two of the output ports 142 and 144 and two of the port interfaces 112 and 114 are used as examples for descriptions in this and some other embodiments. However, a quantity of the output ports and a quantity of the port interfaces should not be construed as limitations to the disclosure. Functions of the above mentioned elements will be described hereinafter.

The chip component 130 is coupled to the central processing unit 110 and the graphics processing unit 120. The chip component 130 is, for example, a southbridge chip such as a platform controller hub (PCH). The chip component 130 is configured for controlling various input and output interfaces or storage interfaces in the electronic device 300. Or, the chip component 130 is, for example, an integration of a southbridge chip a northbridge chip. The chip component 130 comprises a first input and output interface 132 and a second input and output interface 134. In this and some other embodiments, the first input and output interface 132 and the second input and output interface 134 are general purpose I/O (GPIO) interfaces.

The first input and output interface 132 is configured for controlling whether the graphics processing unit 120 is supplied with the power or not. In other words, the first input and output interface 132 is configured for turning on or turning off the main power of the graphics processing unit 120. The second input and output interface 134 is configured for controlling whether the output interfaces 122 and 124 of the graphics processing unit 120 are supplied with the power or not. In other words, the second input and output interface 134 is configured for turning off the power outputted to the output interfaces 122 and 124. In this and some other embodiments, the second input and output interface 134 is coupled to a switching device such as a metal oxide semiconductor (MOS) switch or a switch. The switching device is coupled to the power supply. The switching device is configured for turning on or turning off the power based on outputted signals of the chip component 130, so as to control the power outputted to the output interfaces 122 and 124.

The output ports 142 and 144 are, for example, video transmission interfaces such as display port (DP), video graphics array (VGA) interface or low-voltage differential signaling (LVDS) interface. Nonetheless, the disclosure is not limited thereto. In this and some other embodiments, the output ports 142 and 144 are disposed on the motherboard of the electronic device 300 together with the central processing unit 110. Thereby, the video data processed by the central processing unit 110 is outputted.

The port interfaces 112 and 114 of the central processing unit 110 are, for example, output interfaces corresponding to the output ports 142 and 144. The central processing unit 110 is coupled to the output ports 142 and 144 through the port interfaces 112 and 114 respectively. Specifically, when the output port 142 is a display port, the central processing unit 110 is configured for transmitting a display port signal to the output port 142 through the port interface 112. Or, when the output port 144 is a VGA interface, the central processing unit 110 is configured for transmitting a VGA signal to the output port 144 through the port interface 114.

Furthermore, the materials, arrangements, functions and effects of other elements of the electronic device 300 in FIG. 3 are similar to those of the elements of the electronic device 100 in FIG. 1, and therefore will not be described herein again.

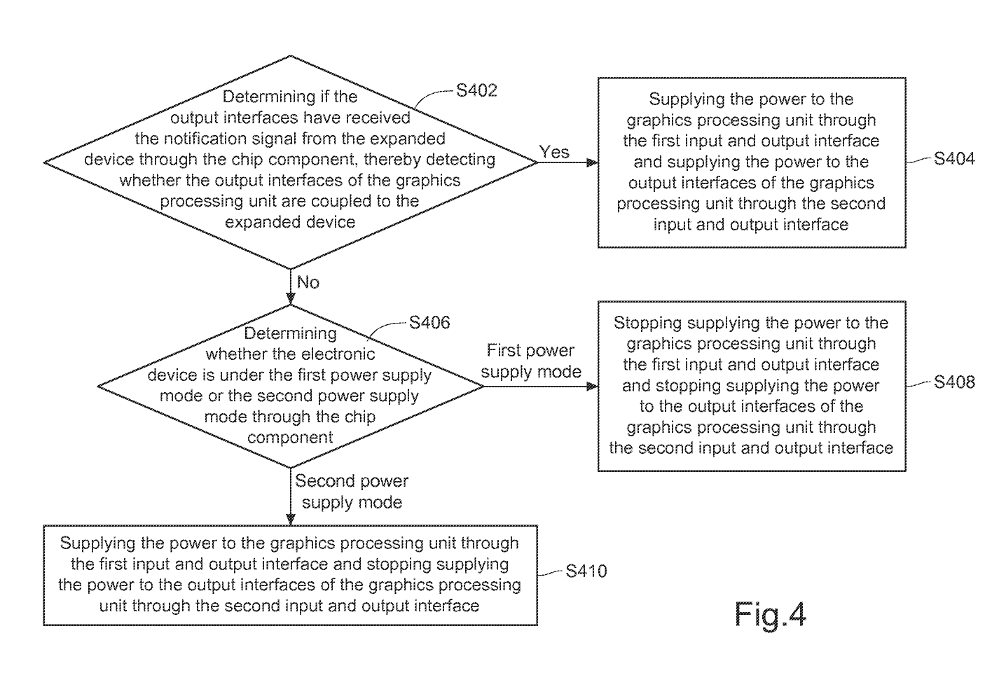

FIG. 4 is a flow chart of the power control method according to the second embodiment of the disclosure. The power control method of this embodiment is configured for using in the electronic device 300 of the second embodiment. Steps of the power control method of this embodiment used with the elements of the electronic device 300 in FIGS. 4 and 3 is described in detail hereinafter.

Please refer to FIG. 3 and FIG. 4 at the same time. In step S402, the chip component 130 determines whether the output interface 122 or the output interface 124 receives a notification signal from the expanded device 10 or not, and detects whether the output interfaces 122 and 124 of the graphics processing unit 120 are coupled to the expanded device 10 or not. In this and some other embodiments, the output interfaces 122 and 124 are disposed on a same cable for transmitting the display port signal and the VGA signal simultaneously. When the cable is coupled to a pin of the expanded device 10 (e.g. the user insert the cable in the expanded device 10), the pin of the expanded device 10 produces a high logic potential signal to notify the chip component 130. The chip component 130 detects that the electronic device 300 is coupled to the expanded device 10 when the chip component 130 receives the high logic potential signal.

In step S404, under the condition that the graphics processing unit 120 is coupled to the expanded device 10 through the output interfaces 122 and 124, the graphics processing unit 120 is supplied with the power by the chip component 130 through the first input and output interface 132, and the output interfaces 122 and 124 of the graphics processing unit 120 are supplied with the power by the chip component 130 through the second input and output interface 134. Since the output interfaces 122 and 124 of the graphics processing unit 120 are coupled to the expanded device 10, and the expanded device 10 receives the external direct current power source or the alternating current power source, the electronic device 300 is supplied with the power through the expanded device 10 when the output interfaces 122 and 124 of the graphics processing unit 120 are coupled to the expanded device 10. Thereby, an amount of consumed battery power of the electronic device 300 is reduced. Therefore, in step 5404, the power for the graphics processing unit 120 and its output interfaces 122 and 124 is turned on.

In step 5406, on the other hand, under the condition that the electronic device 300 is not coupled to the expanded device 10, the chip component 130 determines if the electronic device 300 is under the first power supply mode or the second power supply mode. Similar to step 5206 of the first embodiment, the chip component 130 of this embodiment controls the power supply to supply power based on the first power supply mode and the second power supply mode. Thereby, it is determined whether the central processing unit 110 or the graphics processing unit 120 is employed for processing the video data.

In step 5408, when the electronic device 300 is under the first power supply mode, the chip component 130 stops supplying the power to the graphics processing unit 120 through the first input and output interface 132, and stops supplying the power to the output interfaces 122 and 124 of the graphics processing unit 120 through the second input and output interface 134. For example, the chip component 130 stops the power supply of the electronic device 300 from transmitting the power to the graphics processing unit 120 through the first input and output interface 132. Furthermore, the chip component 130 controls the coupled switching device to turn off the power through the second input and output interface 134. Thereby, the power of the power supply is stopped transmitting to the output interfaces 122 and 124.

On the other hand, the chip component 130 stops supplying the power to the graphics processing unit 120 and the output interfaces 122 and 124. Thereby, the chip component 130 will not transmit the video data to the graphics processing unit 120, and the chip component 130 will not output the video data through the output interfaces 122 and 124 of the graphics processing unit 120. At this point, the chip component 130 transmits the video data to the central processing unit 110, so as to process the video data through the central processing unit 110. The central processing unit 110 transmits the processed video data to the output ports 142 and 144 through the port interfaces 112 and 114, so as to output the video data.

In step S410, when the electronic device 300 is under the second power supply mode, on the other hand, the chip component 130 supplies the power to the graphics processing unit 120 through the first input and output interface 132, and stops supplying the power to the output interfaces 122 and 124 of the graphics processing unit 120 through the second input and output interface 134. In other words, since the chip component 130 supplies the power to the graphics processing unit 120 and stops supplying the power to the output interfaces 122 and 124, the video data is still configured for being processed by the graphics processing unit 120. Afterwards, the processed video data is transmitted to the central processing unit 110, and then the processed video data is outputted through the port interface 112 of the central processing unit 110 and the port interface 114 of the central processing unit 110.

Specifically, when the electronic device 300 is under the second power supply mode, the chip component 130 is configured for transmitting the video data to the graphics processing unit 120 through the transmission interface (e.g. PEG bus) for processing. Moreover, the graphics processing unit 120 is configured for sending back the processed video data to the chip component 130 through the transmission interface. The central processing unit 110 receives the processed video data from the chip component 130 and transmits the processed video data to the output ports 142 and 144 through the port interfaces 112 and 114, so as to output the video data.

Thereby, the chip component 130 of this embodiment is configured for detecting whether the output interfaces 122 and 124 of the graphics processing unit 120 are coupled to the expanded device 10 or not. When the detected result is positive, it indicates that the electronic device 300 is under the alternating current power mode. Therefore, the graphics processing unit 120 and its output interfaces 122 and 124 are supplied with the power. When the detected result is negative, it indicates that the electronic device 300 is under the battery power mode and the chip component 130 turns on or turns off the power for the graphics processing unit 120 and the output interfaces 122 and 124 based on the power supply mode of the electronic device 300. Thereby, an amount of power consumed by the battery is reduced and excellent power-saving effect may be achieved for the electronic device 300. As a conclusion from the above descriptions of the electronic device and the power control method, when the output interfaces of the graphics processing unit are coupled to the expanded device, the electronic device receives the external power through the expanded device, and therefore the power supplied from the electronic device itself is not consumed. Furthermore, when the output interfaces of the graphics processing unit are not coupled to the expanded device, the electronic device stops supplying the power to the output interfaces of the graphics processing unit in order to prevent the starting of the output interfaces of the graphics processing unit from consuming power. Thereby, excellent power-saving effect may be achieved for the electronic device.

Additionally, through the connection method of the electronic device 300 of the embodiment, even one of the display ports and the LVDS interface graphics processing unit are absent, the power control method may still be used and is configured for using in any types of graphics processing unit without having to add switching circuits and peripheral circuits. Thereby, positions of layout placement and space for wiring may be reduced.

What is claimed is:

1. An electronic device, comprising:
a central processing unit; and
a graphics processing unit coupled to the central processing unit, the graphics processing unit comprising a plurality of output interfaces;
wherein a power is supplied to the graphics processing unit and the output interfaces through the coupling between the output interfaces and an expanded device;
wherein under the condition that the output interfaces are not coupled to the expanded device, the power is stopped supplying to the graphics processing unit and the output interfaces when the electronic device is under a first power supply mode, while the power is supplied to the graphics processing unit and is stopped supplying to the output interfaces when the electronic device is under a second power supply mode.

2. The electronic device as claimed in claim 1, further comprising:
a chip component coupled to the central processing unit and the graphics processing unit, the chip component comprising:
a first input and output interface controlling whether the graphics processing unit being supplied with the power or not; and
a second input and output interface controlling whether the output interfaces of the graphics processing unit being supplied with the power or not.

3. The electronic device as claimed in claim 2, wherein under the condition that the output interfaces are coupled to the expanded device, the chip component receives a first notification signal from the expanded device through the output interfaces, thereby, the graphics processing unit is supplied with the power through the first input and output interface, and the output interfaces of the graphics processing unit are supplied with the power through the second input and output interface.

4. The electronic device as claimed in claim 2, wherein under the condition that the output interfaces are not coupled to the expanded device, the chip component determines if the electronic device is under the first power supply mode or the second power supply mode;
when the electronic device is under the first power supply mode, the graphics processing unit is not supplied with the power through the first input and output interface, and the output interfaces of the graphics processing unit are not supplied with the power through the second input and output interface; and
when the electronic device is under the second power supply mode, the graphics processing unit is supplied with the power through the first input and output interface, and the output interfaces of the graphics processing unit are not supplied with the power through the second input and output interface.

5. The electronic device as claimed in claim 1, further comprising a plurality of output ports, wherein the central processing unit comprises a plurality of port interfaces, thereby the central processing unit is coupled to the output ports through the port interfaces respectively.

6. A power control method configured for an electronic device, wherein the electronic device comprises a central processing unit and a graphics processing unit, the power control method comprises steps of:
supplying a power to the graphics processing unit and the output interfaces respectively under the condition that the output interfaces of the graphics processing unit are coupled to an expanded device,; and
under the condition that the output interfaces are not coupled to the expanded device, stopping supplying the power to the graphics processing unit and the output interfaces respectively when the electronic device is under a first power supply mode; and
under the condition that the output interfaces are not coupled to the expanded device, supplying the power to the graphics processing unit and stopping supplying the power to the output interfaces when the electronic device is under a second power supply mode.

7. The power control method as claimed in claim 6, wherein the electronic device has a chip component, the power control method further comprises steps of:
controlling whether the graphics processing unit is supplied with the power or not through a first input and output interface of the chip component; and
controlling whether the output interfaces of the graphics processing unit are supplied with the power or not through a second input and output interface of the chip component.

8. The power control method as claimed in claim 7, wherein supplying the power to the graphics processing unit and the output interfaces respectively under the condition that the output interfaces of the graphics processing unit are coupled to the expanded device comprises steps of:
supplying the power to the graphics processing unit through the first input and output interface; and
supplying the power to the output interfaces of the graphics processing unit through the second input and output interface.

9. The power control method as claimed in claim 7, wherein the power control method under the condition that the output interfaces are not coupled to the expanded device further comprises steps of:
determining if the electronic device is under the first power supply mode or the second power supply mode through the chip component;
when the electronic device is under the first power supply mode, stopping supplying the power to the graphics processing unit through the first input and output interface, and stopping supplying the power to the output interfaces of the graphics processing unit through the second input and output interface; and
when the electronic device is under the second power supply mode, supplying the power to the graphics processing unit through the first input and output interface, and stopping supplying the power to the output interfaces of the graphics processing unit through the second input and output interface.

10. The power control method as claimed in claim 6, wherein the electronic device further comprises a plurality of output ports and the central processing unit comprises a plurality of port interfaces, thereby the central processing unit is coupled to the output ports through the port interfaces respectively.
